(19) United States
(12) Patent Application Publication
(10) Pub. No.: US 2024/0317128 A1
(43) Pub. Date: Sep. 26, 2024

(54) TOWABLE RECREATIONAL VEHICLE WITH UNDER FRAME STORAGE

(71) Applicant: Brinkley RV LLC, Goshen, IN (US)

(72) Inventor: Nathan Goldenberg, Granger, IN (US)

(73) Assignee: Brinkley RV LLC, Goshen, IN (US)

(21) Appl. No.: 18/610,660

(22) Filed: Mar. 20, 2024

Related U.S. Application Data
(60) Provisional application No. 63/453,215, filed on Mar. 20, 2023.

(51) Int. Cl. B60P 3/32; B60J 5/04; B60R 5/00; B62D 25/20

(52) U.S. Cl. CPC B60P 3/32; B60J 5/0491; B60R 5/00; B62D 25/20

(57) ABSTRACT

A towable RV has a frame with a lower portion and upper portion affixed thereto. The lower portion has frame rails that extend uninterrupted from the rear wall to a lower front wall. The lower edges of the frame rails form a plane. The upper portion overhangs the lower front wall and supports an upper floor that extends rearward and overhangs the lower portion. A lower storage area is affixed to and located below the plane formed by the uninterrupted frame rails. An upper storage area is located between the upper floor and uninterrupted frame rails that is accessible from the sides and lower front wall of the RV.

### CROSS REFERENCE TO RELATED APPLICATIONS

This application claims the benefit of Provisional Application Ser. No. 63/453,215, filed Mar. 20, 2023, the disclosure of which is incorporated by reference.

### BACKGROUND OF THE INVENTION

The present disclosure relates to towable recreational vehicles, such as campers and fifth wheel trailers. Storage is always at a premium, as storage space frequently intrudes into the living space. Others have attempted to maximize storage by adding an additional frame rail underneath the main frame rail such as the frames shown in, U.S. Pat. Nos. 8,419,037, and 10,046,690, but this lowers the overall structural rigidity of the frame. Others provide storage below an upper frame, such as U.S. Pat. No. 7,111,897, but this design has a short lower frame and places the weakest point of the frame at a midpoint between the axles and trailer coupler. Therefore, an improved frame with improved rigidity and convenient storage is needed.

### SUMMARY OF THE INVENTION

The present disclosure describes a fifth wheel trailer with storage located underneath the frame rails. The frame of the trailer has two main rails that run from the front to the back. A lower storage area is located underneath the frame rails to provide convenient storage that is closer to the ground than other designs. In addition, the lower storage area provides additional structure and rigidity to the frame instead of weakening it.

The towable recreational vehicle has a frame with a lower portion that is affixed to an upper portion through a connecting portion. The lower portion has continuous lower frame rails that extend from a rear terminal end to a front end, with each lower frame rail having a top edge and an oppositely located bottom edge. The bottom edges of the lower frame rails define a primary lower plane on the recreational vehicle. The upper portion overlays and extends forward of the front end of the frame rails. A lower storage area is affixed to the uninterrupted frame rails and located below the primary lower plane.

### BRIEF DESCRIPTION OF THE DRAWINGS

FIG. 1 is a front right isometric view of the RV;

FIG. 2 is a right side view of the RV in FIG. 1 showing the frame in broken lines;

FIG. 3 is a front right isometric view of the RV in FIG. 1 with the sidewalls, front, back, and roof removed;

FIG. 4 is a front right isometric view of the frame in FIG. 3;

FIG. 5 is a partial view 5 of the frame in FIG. 4;

FIG. 6 is a right side view of the frame in FIG. 4;

FIG. 7 is a partial section 7-7 view of the RV in FIG. 1; and

FIG. 8 is a partial view 8 of the frame in FIG. 6.

### DESCRIPTION OF THE PREFERRED EMBODIMENT

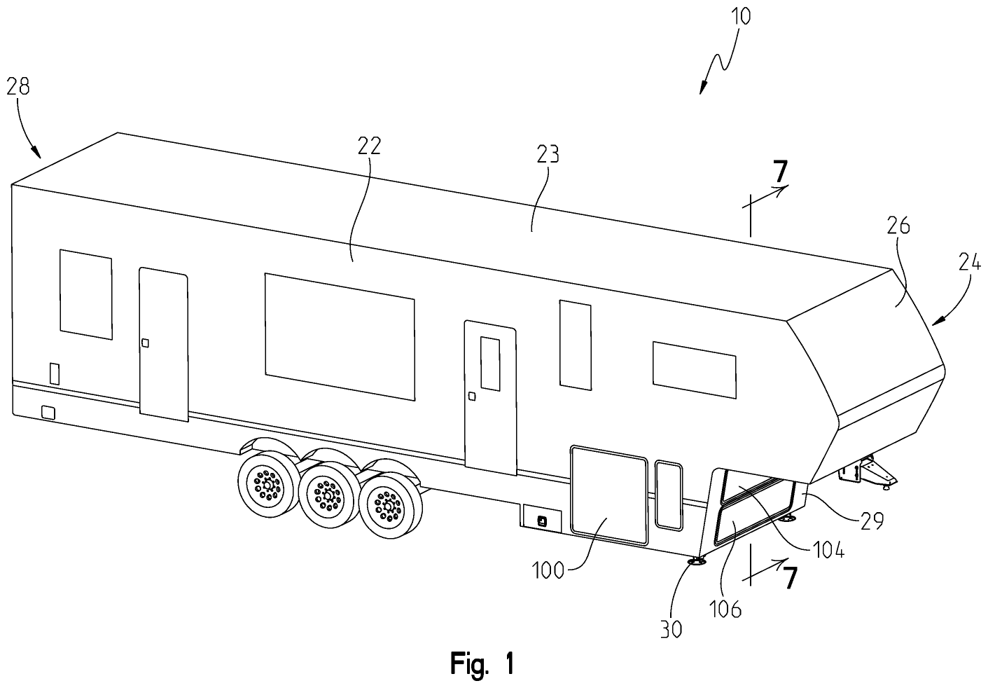

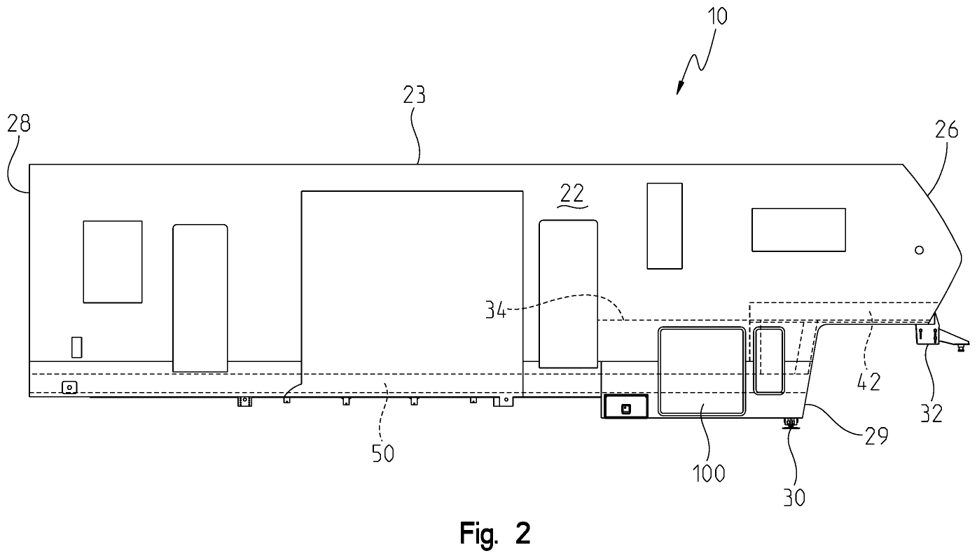

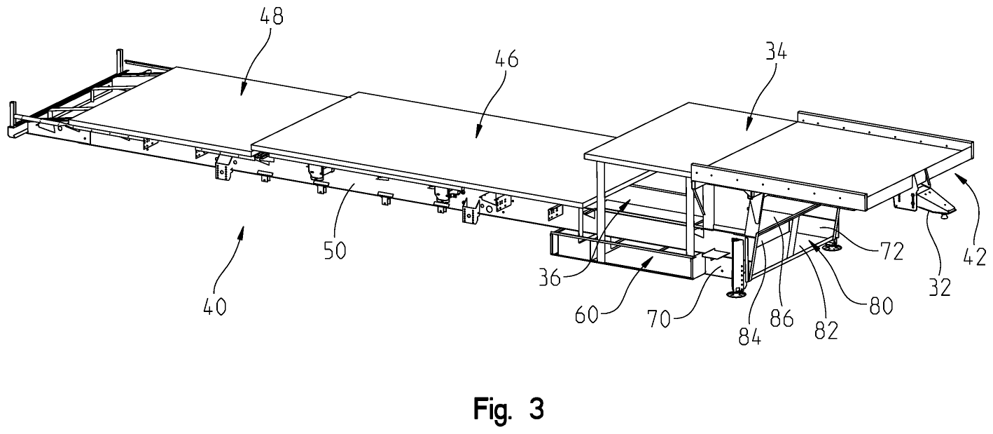

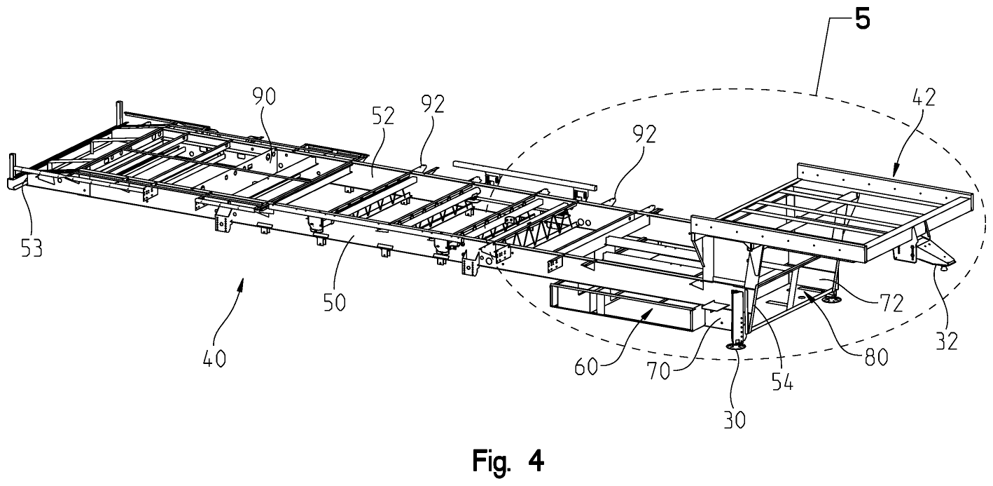

A fifth wheel recreational vehicle 10 is shown in FIGS. 1 and 2 that has a frame 20, side walls 22, 24, a front section or nose 26, and rear 28. A roof 23 connects the nose 26, side walls 22, 24 and rear (liftgate or wall) 28 to enclose the living space. Underneath the nose 26 is a lower front wall 29 that is recessed rearward from the nose 26. FIG. 3 shows the side walls 22, 24, roof, 23, nose 26, and rear 28 removed, leaving the frame 20 and floors 34, 46, 48. FIGS. 4-6 show the vehicle 10 with the flooring removed.

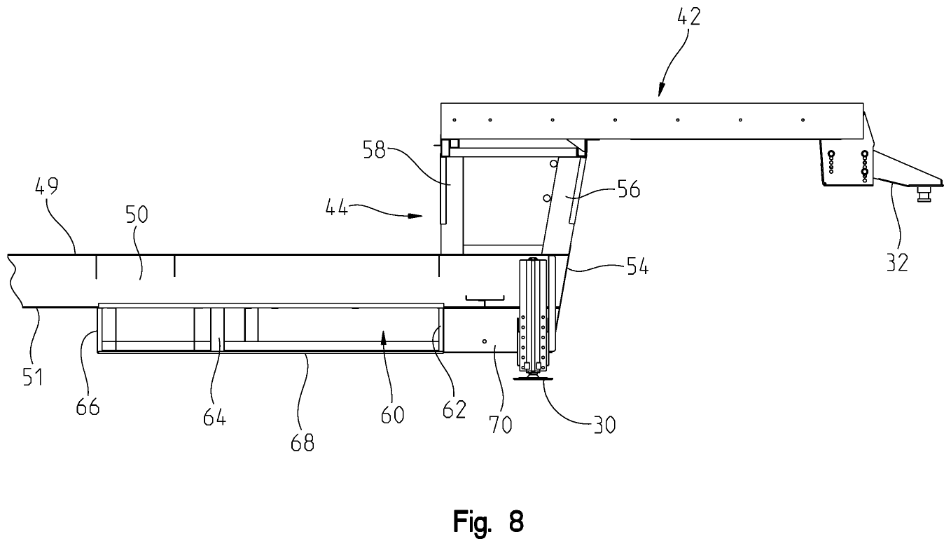

The frame 20 is shown without walls, flooring, or any accessories in FIGS. 4-6 and 8. The frame 20 has a lower portion 40, an upper portion 42, and a connecting portion 44 that structurally connects the lower and upper portions 40, 42. The lower portion 40 has a first frame rail 50 and second frame rail 52 that support the weight of the vehicle and provide attachment points for landing gear 30, walls, suspension, and axles. The frame rails 50, 52 have a top edge 49 and an opposite bottom edge 51. The bottom edges 51 of the frame rails 50, 52 define a primary lower plane 55 that forms the lower structural boundary of the vehicle 10. While some components such as suspension mounts, landing gear, and axles that have structural roles extend below the primary lower plane 55, the main load-bearing, frame, and structural components are located above the primary lower plane 55. Fuel tanks, clean and wastewater tanks can be stored between the frame rails 50, 52 and remain protected from damage. The frame rails 50, 52 extend uninterrupted from a rear terminal end 53 (adjacent the rear 28) to the connecting portion 44 and terminate at a front end 54. The lower portion 40 supports lower flooring, which includes living space flooring 46 and garage flooring 48, shown in FIG. 3. Interior walls, cabinets, appliances, furniture, and other devices (not shown) may be attached to or supported by the flooring 46, 48. Transverse frame members 90 extend between the frame rails 50, 52 and outriggers 92 to provide additional support for flooring and walls.

As previously discussed, the connecting portion 44 connects the lower portion 40 to the upper portion 42. The connecting portion 44 is comprised of structural components such as a front angled member 56 and interior member 58. The connecting portion 44 has similar spacing to the frame rails 50, 52, but unlike the lower portion 40, the connecting portion 44 does not have transverse frame members 90, leaving the space between the front angled member 56 and interior member 58 an open cavity.

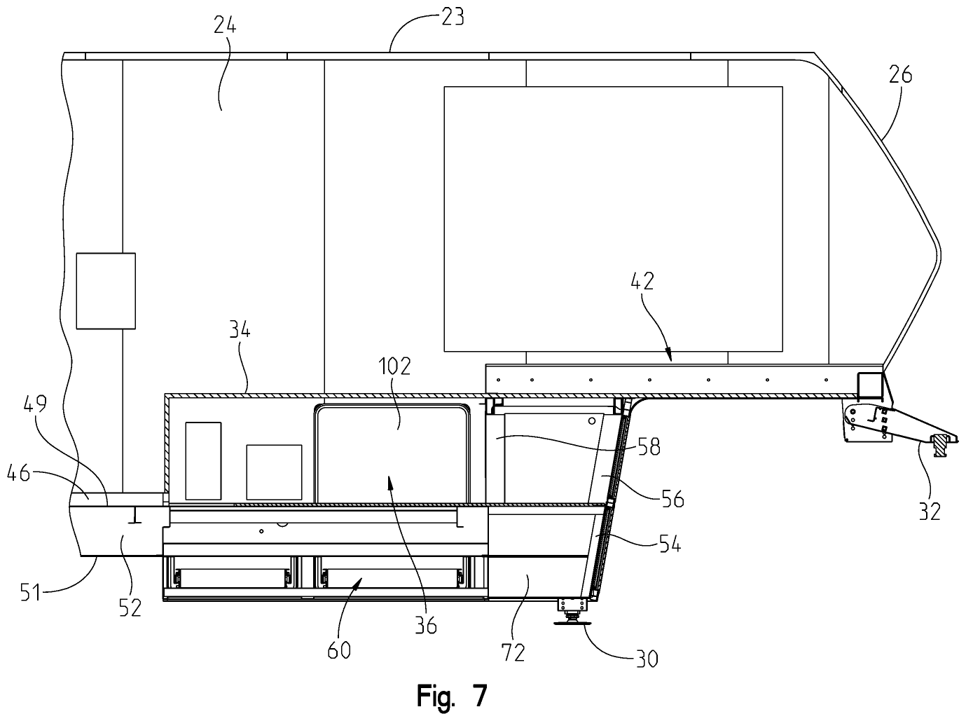

The upper portion 42 affixes to the hitch connection 32 and the connecting portion 44, along with supporting an upper floor 34. As shown in FIGS. 3 and 7, the upper floor 34 extends rearward beyond the upper and connecting portions 42, 44 and over part of the lower portion 40, which creates an upper storage area 36. The upper storage area 36 is located between the top edge 49 of the frame rails 50, 52 and the upper floor 34 and extends forward to the lower front wall 29. The upper storage area 36 represents a clear open area between the side walls 22, 24. The upper storage area 36 extends forward between the structural components of the connecting portion 44 and is accessible at the front of the vehicle 10, as shown in FIG. 3.

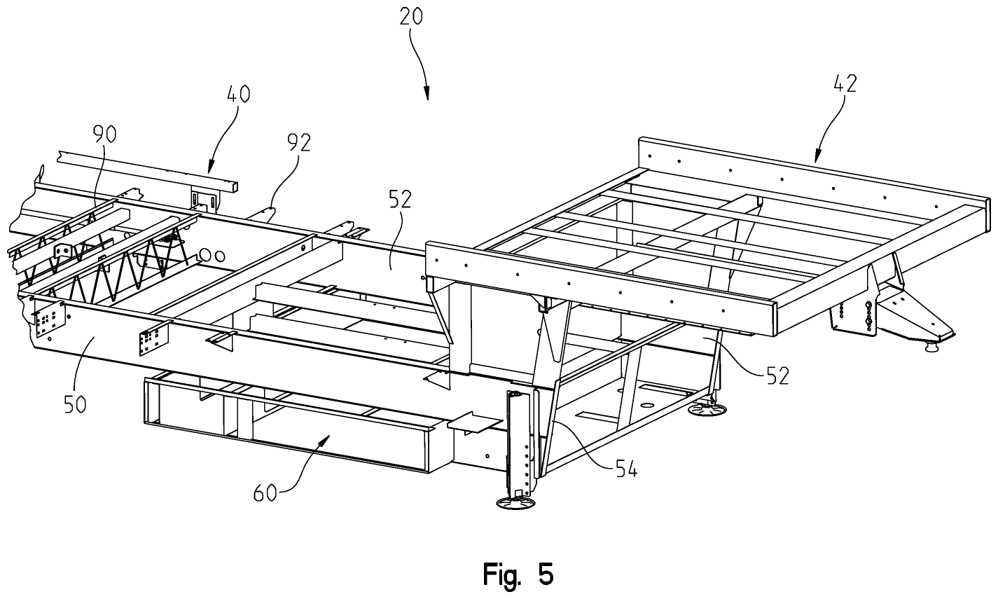

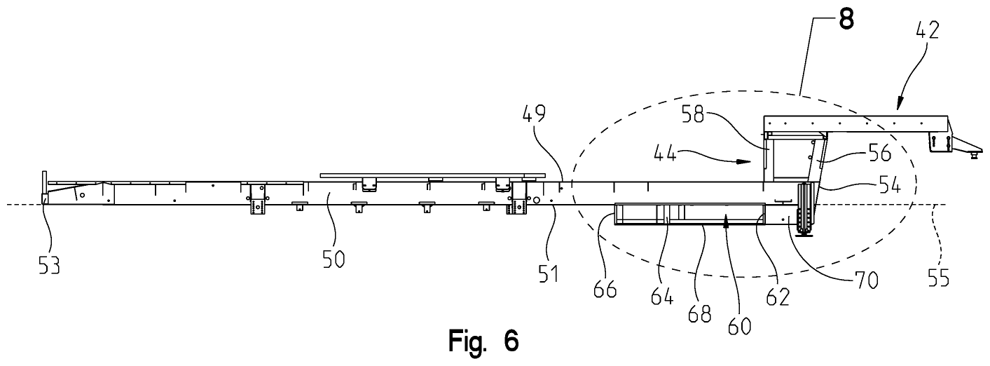

A lower storage area 60 is located below the frame rails 50, 52 and primary lower plane 55 as shown in FIGS. 5 and 6. The lower storage area 60 provides a second clear open area between the sidewalls 22, 24. The lower storage area 60 is formed from and supported by vertical supports 62, 64, 66, and a lower support 68. Located forward of the lower storage area 60 are front bottom members 70, 72 that provide additional rigidity, a place to attach the frontmost landing gear 30, and enclose a front-facing storage space 80. The front-facing storage space 80 is located between the frame rails 50, 52 and front bottom members 70, 72. As shown in FIGS. 3 and 5, the rear of the front-facing storage space 80 has transverse rails 82, 84 which tie the frame rails 50, 52 together. A top wall 86 separates the front-facing storage space 80 from the upper storage area 36.

Side access doors 100, 102 and an upper front access door 104 provide user access to the upper storage area 36. A lower front access door 106 allows user access to the front-facing storage space 80.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A towable recreational vehicle comprising:
a frame having a lower portion affixed to an upper portion, said lower portion having continuous lower frame rails extending from a rear terminal end to a front end, each said lower frame rail having a top edge and an oppositely located bottom edge, said bottom edges of said lower frame rails defining a primary lower plane to said recreational vehicle;
said upper portion overlaying and extending forward of said front end; and
a lower storage area affixed to said uninterrupted frame rails and located below said primary lower plane.

2. The towable recreational vehicle in claim 1, where said upper portion supports an upper floor, said upper floor having an overhanging portion extending rearward beyond said upper portion and overlaying a portion of said lower portion, an upper storage area is located between said top edge of said continuous frame rails and said upper floor.

3. The towable recreational vehicle in claim 2, wherein said upper storage area extends forward to a lower front wall.

4. The towable recreational vehicle in claim 2, wherein said continuous lower frame rails extend between said lower storage area and said upper storage area.

5. The towable recreational vehicle in claim 1, further comprising a lower floor affixed to said top edge of said lower frame rails, said lower floor extending from said rear terminal end and terminating at an upper storage area.

6. The towable recreational vehicle in claim 1, further comprising sidewalls, a roof, a front cap, and a rear wall to form an enclosed living space, an upper and said lower storage areas are accessible from access doors in said sidewalls.

7. The towable recreational vehicle in claim 6, further comprising a lower front wall extending between said sidewalls and located below said upper portion of said frame, said lower front wall having an upper access door, said continuous lower frame rails extending to said lower front wall, said upper storage area is accessible through said upper access door.

8. The towable recreational vehicle in claim 1, further comprising a connecting portion affixed between said lower and upper portions of said frame, a portion of an upper storage area is located between said connecting portion, said upper portion, and said lower portion.

9. A towable recreational vehicle comprising:
a frame having a lower portion affixed to an upper portion, said lower portion having continuous lower frame rails extending from a rear terminal end to a front end, each said lower frame rail having a top edge and an oppositely located bottom edge, said bottom edges of said lower frame rails defining a primary lower plane to said recreational vehicle;
said upper portion overlaying and extending forward of said front end, said upper portion supports an upper floor, said upper floor having an overhanging portion extending rearward beyond said upper portion and overlaying a portion of said lower portion, an upper storage area is located between said top edge of said continuous frame rails and said upper floor, said upper storage area extends to a lower front wall; and
a lower storage area affixed to said uninterrupted frame rails and located below said primary lower plane.

10. The towable recreational vehicle in claim 9, wherein said continuous lower frame rails extend between and separate said lower storage area from said upper storage area.

11. The towable recreational vehicle in claim 9, further comprising sidewalls, a roof, a front cap, and a rear wall to form an enclosed living space, said upper and lower storage areas are accessible from access doors in said sidewalls.

12. The towable recreational vehicle in claim 11, wherein said lower front wall extend between said sidewalls and located below said upper portion of said frame, said lower front wall having an upper access door, said upper storage area is accessible through said upper access door.

13. The towable recreational vehicle in claim 12, wherein said continuous lower frame rails extend uninterrupted from said lower front wall to said rear wall.

14. The towable recreational vehicle in claim 9, further comprising a connecting portion affixed between said lower and upper portions of said frame, a portion of said upper storage area is located between said connecting portion, said upper portion, and said lower portion.

15. A towable recreational vehicle comprising:
sidewalls, a roof, a front cap, and a rear wall to form an enclosed living space;
a frame having a lower portion affixed to an upper portion, said lower portion having continuous lower frame rails extending from a rear terminal end to a front end, each said lower frame rail having a top edge and an oppositely located bottom edge, said bottom edges of said lower frame rails defining a primary lower plane to said recreational vehicle;
said upper portion overlaying and extending forward of said front end; and
a lower storage area affixed to said uninterrupted frame rails and located below said primary lower plane, said lower storage area is accessible from access doors in said sidewalls.

16. The towable recreational vehicle in claim 15, where said upper portion supports an upper floor, said upper floor having an overhanging portion extending rearward beyond said upper portion and overlaying a portion of said lower portion, an upper storage area is located between said top edge of said continuous frame rails and said upper floor, said upper storage area extends forward to a lower front wall.

17. The towable recreational vehicle in claim 16, wherein said continuous lower frame rails extend between and separate said lower storage area from said upper storage area.

18. The towable recreational vehicle in claim 16, further comprising a lower floor affixed to said top edge of said lower frame rails, said lower floor extending from said rear terminal end and terminating at said upper storage area.

19. The towable recreational vehicle in claim 18, further comprising a lower front wall extending between said sidewalls and located below said upper portion of said frame, said lower front wall having an upper access door, said upper storage area is accessible through said upper access door.

20. The towable recreational vehicle in claim 16, further comprising a connecting portion affixed between said lower and upper portions of said frame, a portion of said upper storage area is located between said connecting portion, said upper portion, and said lower portion.
